(19) United States
(12) Patent Application Publication
(10) Pub. No.: US 2025/0165691 A1
(43) Pub. Date: May 22, 2025

(54) METHOD OF DESIGNING SEMICONDUCTOR DEVICE

(71) Applicant: TAIWAN SEMICONDUCTOR MANUFACTURING COMPANY, LTD., Hsinchu (TW)

(72) Inventors: Yong ZHONG, Hsinchu City (TW); Han-Hsuan CHENG, Hsinchu City (TW); Man-Yun CHUNG, Taichung City (TW); Ritvik RATHORE, Hsinchu City (TW); Ya Tung HAN, Chiayi City (TW); Yu-Hao LIU, Hsinchu County (TW); King-Ho TAM, Hsinchu County (TW)

(73) Assignee: TAIWAN SEMICONDUCTOR MANUFACTURING COMPANY, LTD., Hsinchu (TW)

(21) Appl. No.: 18/515,503

(22) Filed: Nov. 21, 2023

(51) Int. Cl. G06F 30/392; G06F 30/20; G06F 119/06

(52) U.S. Cl. CPC G06F 30/392; G06F 30/20; G06F 2119/06

(57) ABSTRACT

A method includes: generating first specification data of a semiconductor device; performing, to the first specification data, a first evaluation operation corresponding to a first physical feature to the first specification data, to generate first parameters; performing, to the first specification data, a second evaluation operation corresponding to a second physical feature different from the first physical feature, to generate second parameters; comparing the first parameters and the second parameters with preset parameters; and when the first parameters and the second parameters meet the preset parameters, manufacturing the semiconductor device according to the first specification data.

### BACKGROUND

Three-dimensional integrated circuit (3DIC) technology allows stacking multiple dies that are electrically connected to each other through hybrid bonding (HBMs) and/or micro bonding (UBMs) and/or through silicon vias (TSVs). Despite 3DIC technologies provide new design dimensions from 2D to 3D IC for further extension of system functionality, the extra available design dimensions from 2D to 3D IC also require comprehensive Design-Technology Co-Optimization (DTCO) for optimization at the system level furthermore to enjoy the benefit from 3DIC, particularly in early design stage.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a three-dimensional schematic diagram of a semiconductor device, in accordance with some embodiments of the present disclosure.

FIG. 1B is a three-dimensional schematic diagram of details of the grid shown in FIG. 1A, in accordance with some embodiments of the present disclosure.

FIG. 2A is a flowchart diagram of a method of designing the semiconductor device shown in FIG. 1A, in accordance with some embodiments of the present disclosure.

FIG. 2B is a flowchart diagram of another aspect of the method shown in FIG. 2A, in accordance with some embodiments of the present disclosure.

FIG. 3 is a flowchart diagram of a method corresponding to the operation shown in FIG. 2B, in accordance with some embodiments of the present disclosure.

FIG. 4 is a flowchart diagram of a method corresponding to the operation shown in FIG. 2A, in accordance with some embodiments of the present disclosure.

FIG. 5 is a flowchart diagram of a method corresponding to the operation shown in FIG. 2A, in accordance with some embodiments of the present disclosure.

FIG. 6 is a flowchart diagram of a method corresponding to the operation shown in FIG. 2A, in accordance with some embodiments of the present disclosure.

FIG. 7 is a flowchart diagram of a method corresponding to the operation shown in FIG. 2B, in accordance with some embodiments of the present disclosure.

FIG. 8 is a flowchart diagram of a method corresponding to the operation shown in FIG. 2A, in accordance with some embodiments of the present disclosure.

FIG. 9 is a flowchart diagram of a method 900 corresponding to the operation shown in FIG. 2B, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

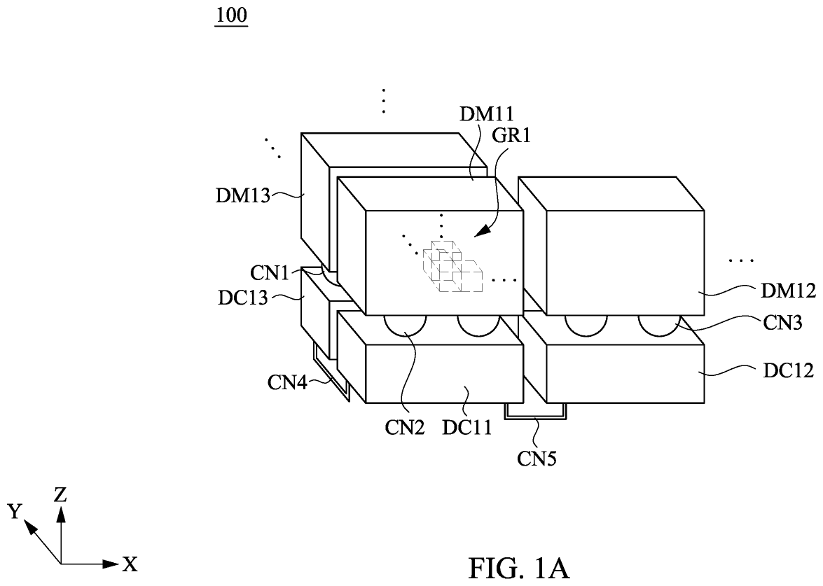

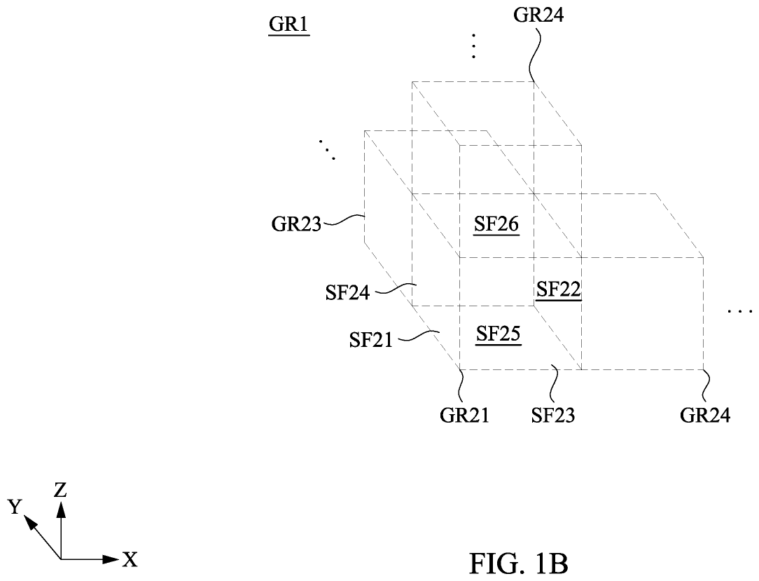

FIG. 1A is a three-dimensional schematic diagram of a semiconductor device 100, in accordance with some embodiments of the present disclosure. As illustratively shown in FIG. 1A, the semiconductor device 100 includes dies DM11-DM13 and DC11-DC13. In some embodiments, the dies DM11-DM13 are implemented by memory dies, and the dies DC11-DC13 are implemented by central processing unit dies, but the embodiments of the present disclosure are not limited to this. In various embodiments, the semiconductor device 100 includes various numbers and various kinds of dies.

As illustratively shown in FIG. 1A, along a Z direction, the dies DM11-DM13 are disposed above the dies DC11-DC13, respectively. The dies DC11 and DC12 are arranged in order along an X direction. The dies DC11 and DC13 are arranged in order along a Y direction. Alternatively stated, the dies DM11-DM13 and DC11-DC13 are distributed in three dimensions. Accordingly, the semiconductor device 100 is referred to as a three-dimensional integrated circuit (3DIC). In some embodiments, the X direction, the Y direction and the Z direction are perpendicular with each other.

As illustratively shown in FIG. 1A, the semiconductor device 100 further includes connections CN1-CN5. The connection CN1 is configured to couple the dies DC13 and DM13 to each other. The connection CN2 is configured to couple the dies DC11 and DM11 to each other. The connection CN3 is configured to couple the dies DC12 and DM12 to each other. The connection CN4 is configured to couple the dies DC13 and DM11 to each other. The connection CN5 is configured to couple the dies DC11 and DM12 to each other.

In some embodiments, the connections CN1-CN5 are implemented by metal bumps, metal lines and/or other kinds of conductive segments. The connections of the semiconductor device 100 are not limited to the connections CN1-CN5. In various embodiments, the dies DM11-DM13 and DC11-DC13 are coupled to each other by various kinds of connections.

As illustratively shown in FIG. 1A, the semiconductor device 100 is divided into multiple grids GR1 for analysis. Further details of the grid GR1 are described below with the embodiments associated with FIG. 1B.

FIG. 1B is a three-dimensional schematic diagram of details of the grids GR1 shown in FIG. 1A, in accordance with some embodiments of the present disclosure. As illustratively shown in FIG. 1B, the grids GR1 includes grids GR21-GR24. The grids GR21 and GR22 are arranged in order along the X direction. The grids GR21 and GR23 are arranged in order along the Y direction. The grids GR21 and GR24 are arranged in order along the Z direction. In various embodiments, various numbers of grids are arranged with the grids GR21-GR24 along the X direction, the Y direction and the Z direction. For simplicity, other grids of the semiconductor device 100 are not shown in FIG. 1B.

As illustratively shown in FIG. 1B, the grid GR21 includes surfaces SF21-SF26. The surfaces SF21 and SF22 are opposite with each other along the X direction. The surfaces SF23 and SF24 are opposite with each other along the Y direction. The surfaces SF25 and SF26 are opposite with each other along the Z direction. The surface SF22 corresponds to a boundary between the grids GR21 and GR22. The surface SF24 corresponds to a boundary between the grids GR21 and GR23. The surface SF26 corresponds to a boundary between the grids GR21 and GR24.

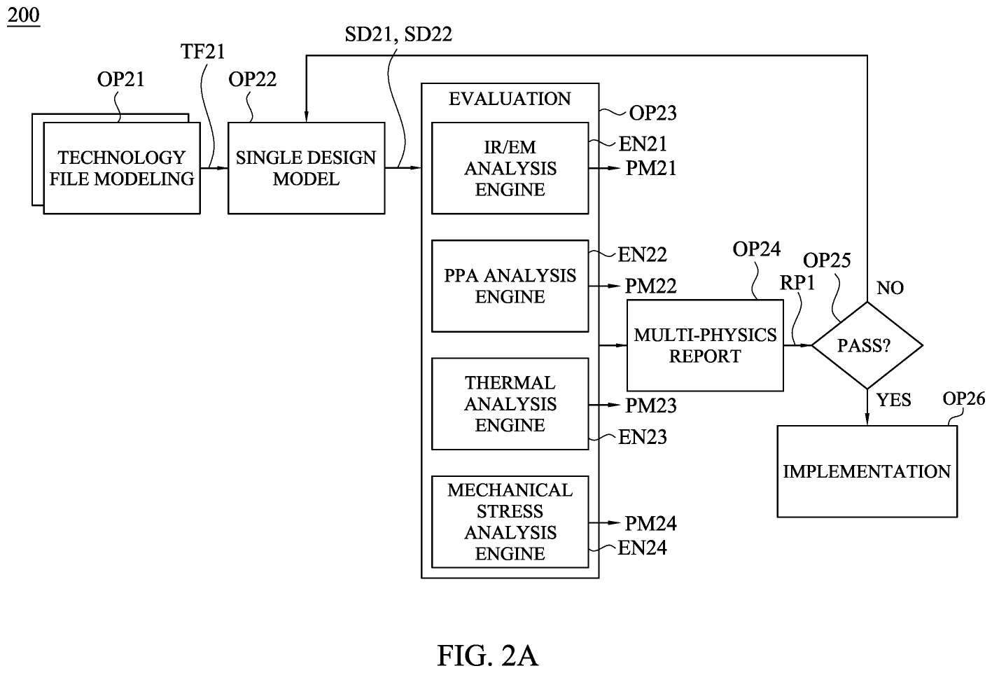

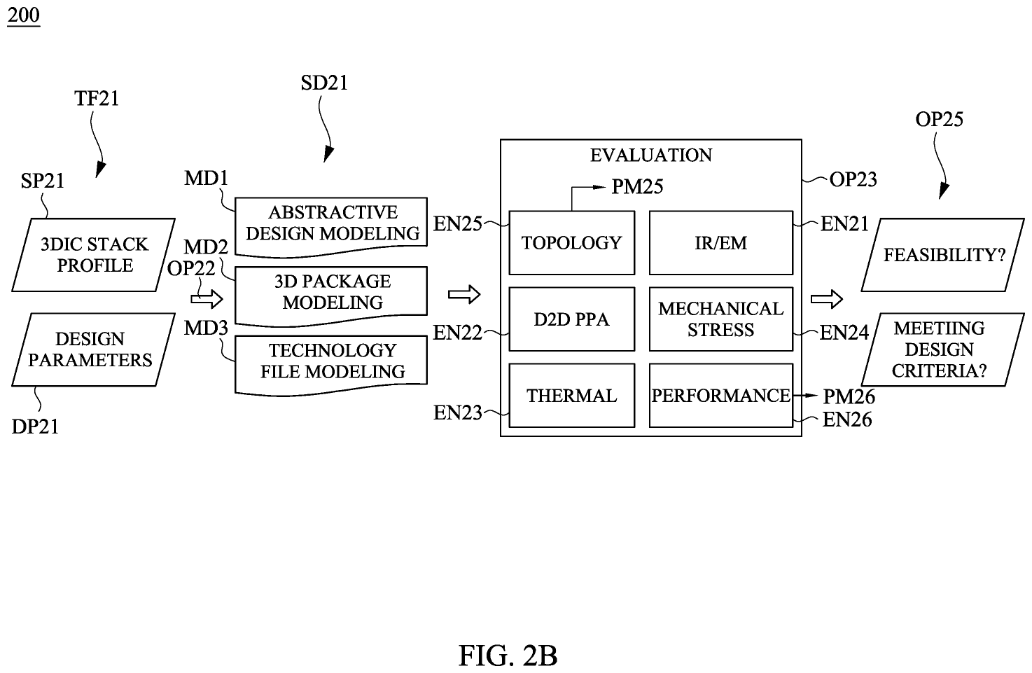

In some embodiments, the semiconductor device 100 is designed according to physical features associated with the surfaces SF21-SF26. Further details of designing the semiconductor device 100 are described below with the embodiments associated with FIG. 2A to FIG. 9.

FIG. 2A is a flowchart diagram of a method 200 of designing the semiconductor device 100 shown in FIG. 1A, in accordance with some embodiments of the present disclosure. As illustratively shown in FIG. 2A, the method 200 includes operations OP21-OP25. In some embodiments, the method 200 is performed by a processor and a memory.

At the operation OP21, a technology file modeling is performed to generate a technology file TF21 of the semiconductor device 100 according to previous technology files of other semiconductor devices. In some embodiments, during an early stage of designing, the technology file of the semiconductor device 100 is incomplete. Accordingly, the technology files modeling is performed according to the previous technology files of the other semiconductor devices, to generate the complete technology file TF21 of the semiconductor device 100. In some embodiments, technology file TF21 includes physical parameters of the semiconductor device 100 from various aspects, such as resistances, capacitances, pitches and widths of the elements in the semiconductor device 100, input signal bandwidths, material of the dies DM11-DM13 and DC11-DC13, electrical conductivities and thermal conductivities.

At the operation OP22, a single design model is built to incorporate the technology file TF21. The single design model is configured to transform the technology file TF21 into a proper format, to generate specification data SD21 of the semiconductor device 100. The specification data SD21 includes parameters arranged in the proper format for the operation OP23.

At the operation OP23, at least one of evaluation operations EN21-EN24 is performed to evaluate the specification data SD21. In some embodiments, the evaluation operations EN21-EN24 are performed by a current-resistor/electromigration (IR/EM) analysis engine, a power-performance-area (PPA) analysis engine, a thermal analysis engine and a mechanical stress analysis engine, respectively. In some embodiments, the analysis engines are implemented by codes stored in the memory and processed by the processor.

At the operation EN21, the specification data SD21 is evaluated to generate parameters PM21 associated with IR/EM features. At the operation EN22, the specification data SD21 is evaluated to generate parameters PM22 associated with PPA features. At the operation EN23, the specification data SD21 is evaluated to generate parameters PM23 associated with thermal features. At the operation EN24, the specification data SD21 is evaluated to generate parameters PM24 associated with mechanical stress features. In some embodiments, at the operation OP23, the at least one of evaluation operations EN21-EN24 is selected to be performed according to the specification data SD21.

For example, when the specification data SD21 includes data associated with the IR/EM features and the PPA features, and does not include data associated with the thermal features and the mechanical stress features, the operations EN21 and EN22 are performed simultaneously and the operations EN23 and EN24 are not performed. For another example, when the specification data SD21 includes data associated with the IR/EM features, the PPA features and the thermal features, and does not include data associated with the mechanical stress features, the operations EN21-EN23 are performed simultaneously and the operation EN24 is not performed.

For a further example, when the specification data SD21 includes data associated with the IR/EM features, the PPA features, the thermal features and the mechanical stress features, the operations EN21-EN24 are performed simultaneously. Alternatively stated, in response to the physical features of the specification data SD21, corresponding one or more of the operations EN21-EN24 is selected and performed in a parallel manner at the operation OP23.

At the operation OP24, a report RP21 is generated according to the parameters from the operation OP23. The report RP21 includes multiple physical parameters (such as one or more of the parameters PM21-PM24) of the semiconductor device 100.

At the operation OP25, the one or more of the parameters PM21-PM24 in the report RP21 are compared with preset parameters corresponding to design criteria. When the report RP21 meets the design criteria, the operation OP26 is performed after the operation OP25. When the report RP21 does not meet the design criteria, the operation OP22 is performed again after the operation OP25, to generate specification data SD22 of the semiconductor device 100 including parameters different from the parameters of the specification data SD21.

Then, the operation OP23 is performed to the specification data SD22, to evaluate whether the specification data SD22 meets the design criteria. Accordingly, one or more of the operations EN21-EN24 are performed to the specification data SD22 to generate parameters of the specification data SD22. Then, at the operation OP25, the parameters of the specification data SD22 are compared with preset parameters. When the specification data SD22 meets the design criteria, the operation OP26 is performed. When the specification data SD22 does not meet the design criteria, other specification data of the semiconductor device is generated.

At the operation OP26, the implementation of the specification data SD21 is performed. For example, the semiconductor device 100 is manufactured according to the specification data SD21.

In some approaches, multiple design models are built for different physical features, to analyze a layout of a semiconductor device. The layout is evaluated corresponding to the different physical features in order independently before implementation. As a result, the turnaround time of the implementation is long, and more calculations are required for generating the layout and performing the evaluations.

Compared to the above approaches, in some embodiments of the present disclosure, two or more of the evaluation operations EN21-EN24 are performed in the parallel manner according to the specification data SD21. Accordingly, the turnaround time of the implementation is reduced, and a layout of the semiconductor device 100 is not required to be generated for the evaluation operations EN21-EN24. As a result, a cost for manufacturing the semiconductor device 100 is reduced.

FIG. 2B is a flowchart diagram of another aspect of the method 200 shown in FIG. 2A, in accordance with some embodiments of the present disclosure. As illustratively shown in FIG. 2B, the technology file TF21 includes a 3DIC stack profile SP21 and design parameters DP21 of the semiconductor device 100. The specification data SD21 includes abstractive design modeling data MD1, 3D package modeling data MD2 and technology file modeling data MD3.

In some embodiments, at the operation OP22, each of the modeling data MD1-MD3 is generated according to each of the 3DIC stack profile SP21 and the design parameters DP21. The modeling data MD1 includes chiplet definition of the semiconductor device 100. The modeling data MD2 includes stack topology definition of the semiconductor device 100. The modeling data MD3 includes technology parameters and design specifications of the semiconductor device 100.

In some embodiments, the modeling data MD1 includes one or more of following information: metal layer and/or redistribution layer with power/ground (PG) specification (direction, density, width and via count), specification of interconnect (for example, physical dimension, pitch and count of through silicon via (TSV), bump, through InFO via (TIV)), power consumption, current density or current profile specification, hotspot, PG guide (blockage or connection), capacitor model, system package model, die-to-die (D2D) interface design style, signal count, power pin count or signal over PG (S/PG) ratio, clocking style (src-sync/sys-sync), toggle rate, variation (corner, on chip variation), logical-wise connectivity between D2D interfaces, thermal layer thickness, thermal conductivity, ambient temperature, heat transfer coefficient, Mechanical stress-induced physical failure risk (excessive warpage, crank, delamination, etc.) and/or device performance shift.

In some embodiments, the modeling data MD2 includes information associated with quantities, positions, arrangements and connections of the dies of the semiconductor device 100 (for example, information of the dies DM11-DM13 being stacked on the dies DM11-DM13, respectively, and information of the connections CN1-CN5 as shown in FIG. 1A).

In some embodiments, the modeling data MD1 includes one or more of following information: resistance and capacitance specification of metal and via for different metal scheme, interconnect CD, pitch of bump and TSV, resistance, capacitance, EM limit, D2D interface configuration and 2D/3D die metal configuration.

As illustratively shown in FIG. 2B, the operation OP23 further includes evaluation operations EN25 and EN26. In some embodiments, the operations EN25 and EN26 are performed by a topology sanity checker and a system performance engine, respectively. In some embodiments, the topology sanity checker and the system performance engine are implemented by codes stored in the memory and processed by the processor.

At the operation EN25, the specification data SD21 is evaluated to generate parameters PM25 associated with topology features. At the operation EN26, the specification data SD21 is evaluated to generate parameters PM26 associated with system performance features. In some embodiments, at the operation OP23, the at least one of operations EN21-EN26 is selected to be performed according to the specification data SD21. At the operation OP25, feasibility of the specification data SD21 is evaluated, and determines whether the specification data SD21 meets the design criteria, by comparing the parameters PM21-PM26 and the preset parameters.

At the operation OP25, the one or more of the parameters PM21-PM26 are compared with the preset parameters corresponding to the design criteria, to determine whether the specification data SD21 meets the design criteria. When the specification data SD21 meets the design criteria and has feasibility, the operation OP26 shown in FIG. 2A is performed after the operation OP25. When the specification data SD21 does not meet the design criteria or does not have feasibility, the operation OP22 is performed again after the operation OP25.

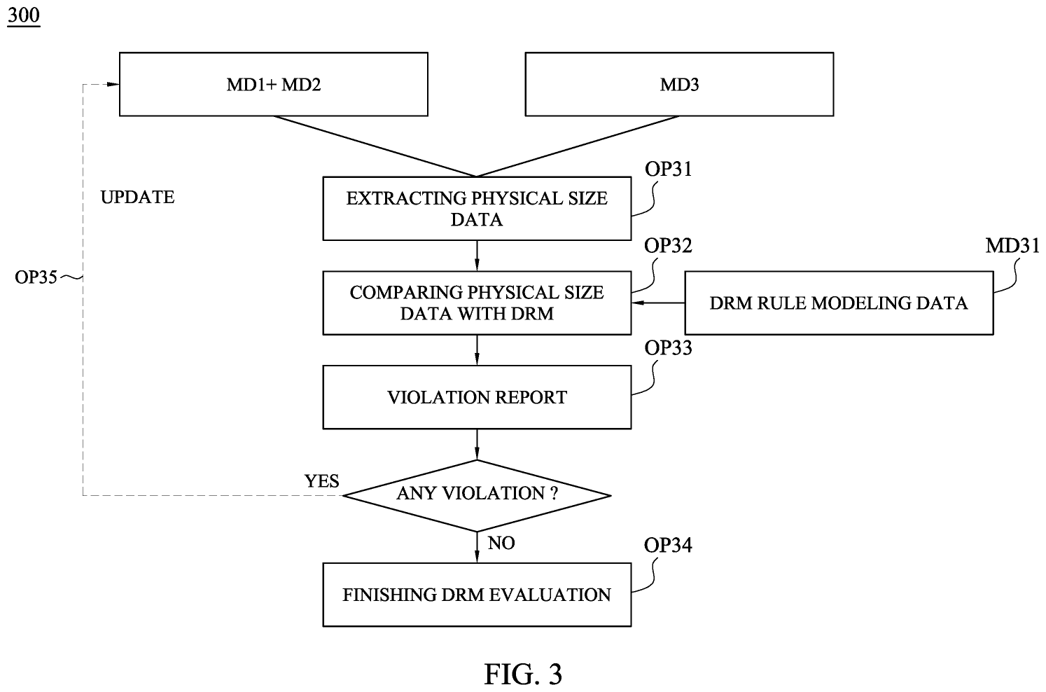

FIG. 3 is a flowchart diagram of a method 300 corresponding to the operation EN25 shown in FIG. 2B, in accordance with some embodiments of the present disclosure. As illustratively shown in FIG. 3, the method 300 includes operations OP31-OP36. In some embodiments, the method 300 is performed by a processor and a memory.

At the operation OP31, physical size data of the semiconductor device 100 is extracted from the modeling data MD1-MD3. In some embodiments, the physical size data includes the lengths of the dies DM11-DM13 and DC11-DC13 along X direction, Y direction and Z direction, pitches between the dies DM11-DM13 and DC11-DC13, density (such as metal density) of the semiconductor device 100, and other physical parameters of the semiconductor device 100. Referring to FIG. 3 and FIG. 2B, the physical size data includes the parameters PM25 in some embodiments.

At the operation OP32, the physical size data is compared with high-level design rule manual (DRM) rules modeling data MD31, to check whether the physical size data meets the design criteria associated with the DRM rules. For example, when the DRM rules modeling data MD31 requires a metal density smaller than 80% and the metal density of the physical size data is larger than 80%, the processor determines that the physical size data does not meet the design criteria. In some embodiments, the operation OP32 is performed by a DRM checker corresponding to the topology sanity checker shown in FIG. 2B.

At the operation OP33, a violation report is generated according to the comparison result of the operation OP32. When the physical size data meets the design criteria, the violation report indicates that there is no violation regarding the DRM rules modeling data MD31. When the physical size data does not meet the design criteria, the violation report indicates that at least one violation exists regarding the DRM rules modeling data MD31.

When no violation in the violation report, the operation OP34 is performed after the operation OP33. When at least one violation exists in the violation report, the operation OP35 is performed after the operation OP33.

At the operation OP34, the evaluation of DRM rules for the specification data SD21 is finished. In some embodiments, after the operation OP34, implementations of the specification data SD21, such as the operation OP26 shown in FIG. 2A, is performed. In some embodiments, after the operation OP34, other evaluations are performed to the specification data SD21.

At the operation OP35, the modeling data MD1, MD2 is updated according to the violation report. For example, when the violation report indicates that the metal density of the specification data SD21 does not meet the design criteria, parameters in the modeling data MD1, MD2 associated with the metal density are adjusted. It is noted that the modeling data MD3 is fixed and not updated at the operation OP35. After the operation OP35, the operation OP31 is performed again to the updated modeling data MD1, MD2 and the fixed modeling data MD3.

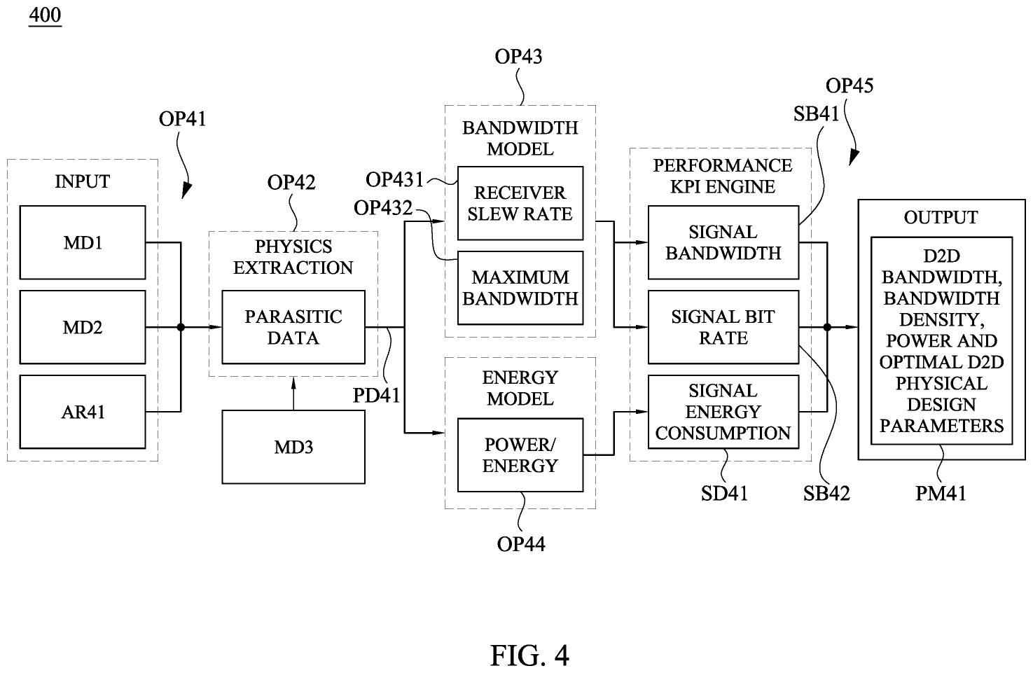

FIG. 4 is a flowchart diagram of a method 400 corresponding to the operation EN22 shown in FIG. 2A, in accordance with some embodiments of the present disclosure. As illustratively shown in FIG. 4, the method 400 includes operations OP41-OP45. In some embodiments, the method 400 is performed by a processor and a memory.

At the operation OP41, the modeling data MD1 and MD2 are inputted into the processor for a D2D bandwidth evaluation. In some embodiments, an analysis result AR41 is further inputted into the processor for the D2D bandwidth evaluation. The analysis result AR41 including results of other evaluations, such as the evaluations from one or more of the operations EN21 and EN23-EN26. It is noted that analysis result AR41 is not necessary to the operation OP41. The operation OP41 is performable without the analysis result AR41.

At the operation OP42, physical parameters associated with the D2D bandwidth evaluation are extracted from the modeling data MD1-MD3. For example, a stack profile is extracted from the modeling data MD1, D2D interconnection specifications (such as bit count and signal power ratio) are extracted from the modeling data MD2, and electrical parasitic data (such as resistance and capacitance of metal segments, vias, bumps and/or TSV) is extracted from the modeling data MD3. Then, channel parasitic data PD41 of the semiconductor 100 is extracted from these physical parameters.

At the operation OP43, signal bandwidths SB41 and signal bit rates SB42 of the semiconductor device 100 are generated according to the channel parasitic data PD41. In some embodiments, the operation OP43 is performed by a bandwidth model. As illustratively shown in FIG. 4, the operation OP43 includes operations OP431 and OP432.

At the operation OP431, receiver slew rate calculations are performed to the channel parasitic data PD41. At the operation OP432, maximum bandwidth calculations are performed to the channel parasitic data PD41. Referring to FIG. 4 and FIG. 1A, the receiver slew rates and the maximum bandwidths are features of signals transmitted between the dies DM11-DM13 and DC11-DC13.

At the operation OP44, signal energy consumption data SD41 of the semiconductor 100 is generated by performing power/energy breakdown calculations according to the channel parasitic data PD41. In some embodiments, the power/energy breakdown calculations includes summing energy consumptions of various signal (such as clock signals and data signals) transmitting through dies (such as the dies DC11-DC13 and DM11-DM13). In some embodiments, the operation OP44 is performed by an energy model including power models of data transmitters, data receivers and channels. In some embodiments, the data receivers are the dies receiving the data signals, and the data transmitters are the dies transmitting the data signals.

At the operation OP45, parameters PM41 are generated according to the signal bandwidths SB41, the signal bit rates SB42 and the signal energy consumption data SD41. In some embodiments, the parameters PM41 include D2D bandwidth, bandwidth density, power and optimal D2D physical design parameters of the semiconductor device 100.

In some embodiments, after the operation OP45, the parameters PM41 are compared with the preset parameters corresponding to the design criteria. When the parameters PM41 meet the design criteria, the semiconductor device 100 is manufactured based on the modeling data MD1-MD3. When the parameters PM41 does not meet the design criteria, the modeling data MD1 and MD2 are adjusted, and then the operations OP41-OP45 are performed again to the adjusted modeling data MD1 and MD2 and the fixed modeling data MD3.

For example, referring to FIG. 4 and FIG. 2A, after the operation OP45, the operation OP25 is performed to the parameters PM41. The parameters PM41 are embodiments of the parameters PM22. When the parameters PM41 meet the design criteria, the operation OP26 is performed. When the parameters PM41 does not meet the design criteria, the operation OP22 is performed again to update the specification data SD21 including the modeling data MD1 and MD2.

In some embodiments, the operations OP41-OP45 are performed multiple times to different modeling data MD2, to generate corresponding outputs. Then, the processor compares the outputs to select one of the outputs for implementation.

For example, the operations OP41-OP45 are performed three times to modeling data MD2(1)-MD2(3), respectively, to generate parameters PM41(1)-PM41(3). The modeling data MD2(1)-MD2(3) correspond to three different design specifications (such as three kind of material), respectively. The parameters PM41(1)-PM41(3) correspond to the modeling data MD2(1)-MD2(3), respectively.

After the parameters PM41(1)-PM41(3) are generated, the processor compares the parameters PM41(1)-PM41(3) with each other, to select one of the parameters PM41(1)-PM41(3) for implementation. For example, when a bandwidth of the parameters PM41(1) is larger than each of a bandwidth of the parameters PM41(2) and a bandwidth of the parameters PM41(3), the parameters PM41(1) are selected for manufacturing the semiconductor device 100.

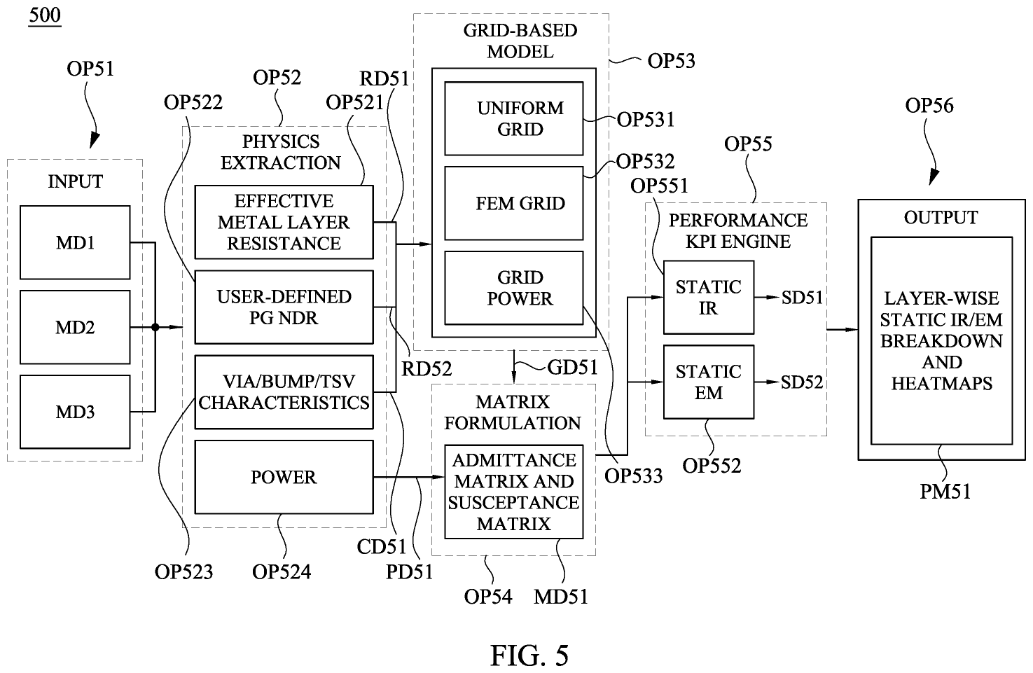

FIG. 5 is a flowchart diagram of a method 500 corresponding to the operation EN21 shown in FIG. 2A, in accordance with some embodiments of the present disclosure. As illustratively shown in FIG. 5, the method 500 includes operations OP51-OP56. In some embodiments, the method 500 is performed by a processor and a memory.

At the operation OP51, the modeling data MD1-MD3 are inputted into the processor for a static IR/EM evaluation.

At the operation OP52, physical parameters associated with the static IR/EM evaluation are extracted from the modeling data MD1-MD3. As illustratively shown in FIG. 5, the operation OP52 includes operations OP521-OP524.

At the operation OP521, effective metal layer resistance data RD51 of the semiconductor device 100 is extracted from the modeling data MD1-MD3. In some embodiments, the effective metal layer resistance data RD51 includes resistances of multiple metal layers in the semiconductor device 100.

At the operation OP522, user-defined PG non-default rules (NDR) data RD52 of the semiconductor device 100 is extracted from the modeling data MD1-MD3. In some embodiments, the user-defined PG NDR data RD52 includes pitches and widths of conductive lines in the semiconductor device 100.

At the operation OP523, characteristic data CD51 of the semiconductor device 100 is extracted from the modeling data MD1-MD3. In some embodiments, the characteristic data CD52 includes resistances and capacitances of vias, bumps and TSV of the semiconductor device 100.

At the operation OP524, power data PD51 of the semiconductor device 100 is extracted from the modeling data MD1-MD3. In some embodiments, the power data PD51 includes data associated with power consumed by the semiconductor device 100 corresponding to different input signals, such as voltage levels of the input signals.

At the operation OP53, grid data GD51 is generated according to the effective metal layer resistance data RD51, the user-defined PG NDR data RD52 and the characteristic data CD51. In some embodiments, the operation OP53 is performed by a grid-based model. Referring to FIG. 1A and FIG. 5, the grid data GD51 is associated with physical values of each of the grids GR1.

As illustratively shown in FIG. 5, the operation OP53 includes operations OP531-OP533. At the operation OP531, uniform grids of the semiconductor device 100 are formulated. For example, the grids GR1 are uniform. At the operation OP532, finite element method (FEM) grids of the semiconductor device 100 are formulated. For example, the grids GR1 are finite. At the operation OP533, grid power calculation is performed.

For example, at the operation OP533, electrical conductivities of each of the grids GR1 is calculated according material, metal pitches and metal widths of multiple metal layers of the semiconductor device 100, and a value of power consumed each of the grids GR1 is calculated according to the electrical conductivities. Referring to FIG. 1B, each of the grids GR1 has six electrical conductivities corresponding to six surfaces of the grid. For example, the grid GR21 has six electrical conductivities corresponding to the surfaces SF21-SF26, respectively. In some embodiments, the grid data GD51 includes the values of power consumed by the grids GR1 arranged as a matrix. In some embodiments, the power consumed by the grids GR1 corresponds to IR voltage drop, such as an IR voltage drop when a signal passing though the grids GR1.

At the operation OP54, matrix formulation is performed to the grid data GD51 and the power data PD51 to generate matrix data MD51. In some embodiments, the matrix data MD51 includes an admittance matrix and a susceptance matrix associated with static IR of the entire semiconductor device 100. In some embodiments, the matrix data MD51 includes power values of each of the grids GR1. In some embodiments, the matrix data MD51 is generated by performing modified nodal analysis (MNA).

At the operation OP55, static IR/EM analysis is performed to the matrix data MD51. In some embodiments, the operation OP55 is performed by a performance key performance indicator (KPI) engine. As illustratively shown in FIG. 5, the operation OP55 includes operations OP551-OP552.

At the operation OP551, static IR analysis is performed to the matrix data MD51 to generate static IR data SD51. In some embodiments, the static IR data SD51 includes voltage values consumed by the grids GR1 (voltage per grid), information of grids having worst IR drop, and minimum resistance path in the semiconductor device 100.

At the operation OP552, static EM analysis is performed to the matrix data MD51 to generate static EM data SD52. In some embodiments, the static EM data SD52 includes EM current values and layer-wise average current values of the semiconductor device 100.

At the operation OP56, parameters PM51 are generated according to the static IR data SD51 and the static EM data SD52. In some embodiments, the parameters PM51 include a report of layer-wise static IR/EM breakdown of the semiconductor device 100, and 2D/3D heatmaps of static IR distribution and current distribution.

In some embodiments, after the operation OP56, the parameters PM51 are compared with the preset parameters corresponding to the design criteria. When the parameters PM51 meet the design criteria, the semiconductor device 100 is manufactured based on the modeling data MD1-MD3. When the parameters PM51 does not meet the design criteria, the modeling data MD1 and MD2 are adjusted, and then the operations OP51-OP56 are performed again to the adjusted modeling data MD1 and MD2 and the fixed modeling data MD3.

For example, referring to FIG. 5 and FIG. 2A, after the operation OP56, the operation OP25 is performed to the parameters PM51. The parameters PM51 are embodiments of the parameters PM21. When the parameters PM51 meet the design criteria, the operation OP26 is performed. When the parameters PM51 does not meet the design criteria, the operation OP22 is performed again to update the specification data SD21 including the modeling data MD1 and MD2.

For a specific example, when an IR drop value in the parameters PM51 is larger than a preset IR drop value of the design criteria, a metal width in the modeling data MD2 is increased, to decrease the IR drop value in the parameters PM51.

For another specific example, when an EM current value in the parameters PM51 is larger than a preset EM current value of the design criteria, a quantity of vias in the modeling data MD2 is increased, to decrease the EM current value in the parameters PM51.

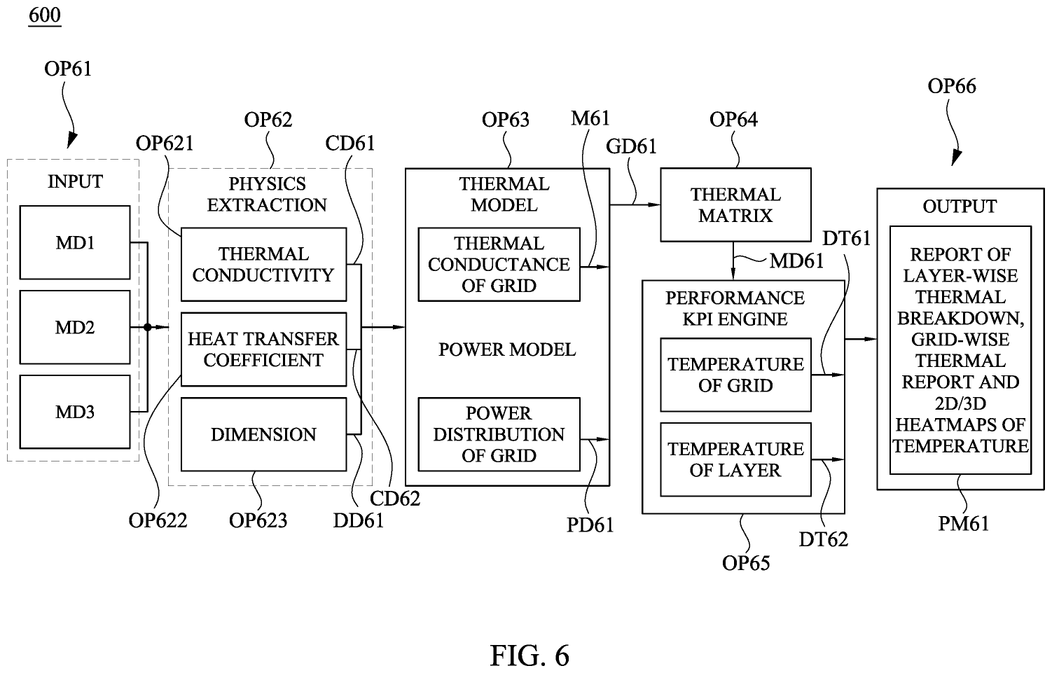

FIG. 6 is a flowchart diagram of a method 600 corresponding to the operation EN23 shown in FIG. 2A, in accordance with some embodiments of the present disclosure. As illustratively shown in FIG. 6, the method 600 includes operations OP61-OP66. In some embodiments, the method 600 is performed by a processor and a memory.

At the operation OP61, the modeling data MD1-MD3 are inputted into the processor for a thermal evaluation.

At the operation OP62, physical parameters associated with the thermal evaluation are extracted from the modeling data MD1-MD3. As illustratively shown in FIG. 5, the operation OP62 includes operations OP621-OP623.

At the operation OP621, conductivity data CD61 of the semiconductor device 100 is extracted from the modeling data MD1-MD3. In some embodiments, the conductivity data CD61 includes thermal conductivities of surfaces (such as the surfaces SF21-SF26) of dies (such as the dies DM11-DM13 and DC11-DC13 shown in FIG. 1B) and thermal conductivities of molding (such as material surrounding and packaging the dies DM11-DM13 and DC11-DC13).

At the operation OP622, coefficient data CD62 of the semiconductor device 100 is extracted from the modeling data MD1-MD3. In some embodiments, the coefficient data CD62 includes heat transfer coefficients of the semiconductor device 100.

At the operation OP623, dimension data DD61 of the semiconductor device 100 is extracted from the modeling data MD1-MD3. In some embodiments, the dimension data DD61 includes dimension information of the semiconductor device 100, such as widths, heights, lengths and positions of the dies DM11-DM13, DC11-DC13 and the molding, and the stack relationships.

At the operation OP63, grid data GD61 is generated according to the conductivity data CD61, the coefficient data CD62 and the dimension data DD61. As illustratively shown in FIG. 6, the operation OP63 includes operations OP631-OP632.

At the operation OP631, grid-based thermal conductance calculations are performed to generate a matrix data M61. For example, six thermal conductance values corresponding to the six surfaces SF21-SF26 are calculated according to the conductivity data CD61, the coefficient data CD62 and the dimension data DD61. The matrix data M61 includes thermal conductance values of each of the grids GR1. In some embodiments, the operation OP631 is performed by a thermal model.

At the operation OP632, power data PD61 is generated according to the conductivity data CD61, the coefficient data CD62 and the dimension data DD61. In some embodiments, the power data PD61 includes power distribution of the grids GR1 (such as respective values of power consumed by the grids GR1) and hot spot specification. In some embodiments, the operation OP632 is performed by a power model. After the operations OP631 and OP632, the grid data GD61 is generated according to the matrix data M61 and the power data PD61.

At the operation OP64, matrix data MD61 is constructed according to the grid data GD61. In some embodiments, the matrix data MD61 includes temperature values of each of the grids GR1. In some embodiments, the matrix data MD61 includes an MNA matrix of thermal conductance of the semiconductor device 100.

At the operation OP65, temperature analysis is performed to the matrix data MD61. In some embodiments, the operation OP65 is performed by a performance KPI engine. As illustratively shown in FIG. 6, the operation OP65 includes operations OP651-OP652.

At the operation OP651, temperature data DT61 is generated according to the matrix data MD61. In some embodiments, the temperature data DT61 includes respective temperature values of the grids GR1. In some embodiments, the operation OP651 is performed by a grid-based temperature solver.

At the operation OP652, temperature data DT62 is generated according to the matrix data MD61. In some embodiments, the temperature data DT62 includes a minimum temperature value, a maximum temperature value and a mean temperature value of each of the metal layers of the semiconductor device 100.

At the operation OP66, parameters PM61 are generated according to the temperature data DT61 and DT62. In some embodiments, the parameters PM61 include a report of layer-wise thermal breakdown of the semiconductor device 100, and a grid-wise thermal report and 2D/3D heatmaps of temperature.

In some embodiments, after the operation OP66, the parameters PM61 are compared with the preset parameters corresponding to the design criteria. When the parameters PM61 meet the design criteria, the semiconductor device 100 is manufactured based on the modeling data MD1-MD3. When the parameters PM61 does not meet the design criteria, the modeling data MD1 and MD2 are adjusted, and then the operations OP61-OP66 are performed again to the adjusted modeling data MD1 and MD2 and the fixed modeling data MD3.

For example, referring to FIG. 6 and FIG. 2A, after the operation OP66, the operation OP25 is performed to the parameters PM61. The parameters PM61 are embodiments of the parameters PM23. When the parameters PM61 meet the design criteria, the operation OP26 is performed. When the parameters PM61 does not meet the design criteria, the operation OP22 is performed again to update the specification data SD21 including the modeling data MD1 and MD2.

For a specific example, when a temperature value in the parameters PM61 is larger than a preset temperature value of the design criteria, material of a part of the semiconductor device 100 having the temperature value is changed, to decrease the temperature value in the parameters PM61.

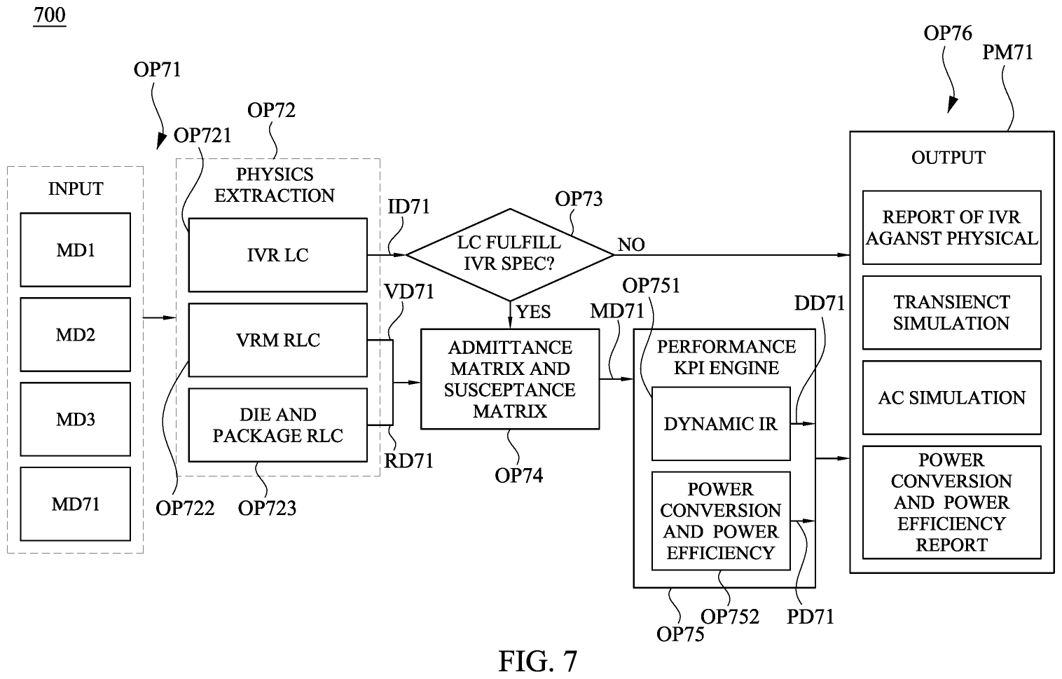

FIG. 7 is a flowchart diagram of a method 700 corresponding to the operation EN21 shown in FIG. 2B, in accordance with some embodiments of the present disclosure. As illustratively shown in FIG. 7, the method 700 includes operations OP71-OP76. In some embodiments, the method 700 is performed by a processor and a memory.

At the operation OP71, the modeling data MD1-MD3 and MD71 are inputted into the processor for a dynamic IR evaluation. Referring to FIG. 1A, the semiconductor device 100 further includes a printed circuit board (PCB) and integrated voltage regulators (IVR) in some embodiments. For simplicity, the PDB and the IVR are not shown in FIG. 1A. In some embodiments, the modeling data MD71 includes data associated with bucks and PCB decoupling capacitors of the PDB and the IVR.

In some embodiments, for the dynamic IR evaluation, the modeling data MD1 includes at least a part of data associated with intrinsic, super high density metal-insulator-metal (SHDMIM), deep trench capacitor (DTC) and the modeling data MD2 includes at least a part of data associated with power consumption and PG specification.

At the operation OP72, physical parameters associated with the dynamic IR evaluation are extracted from the modeling data MD1-MD3 and MD71. As illustratively shown in FIG. 7, the operation OP72 includes operations OP721-OP723.

At the operation OP721, IVR data ID71 of the semiconductor device 100 is extracted from the modeling data MD1-MD3 and MD71. In some embodiments, the IVR data ID71 includes inductances and capacitances (LC) of the IVR.

At the operation OP722, VRM (voltage regulator module) data VD71 of the IVR is extracted from the modeling data MD1-MD3 and MD71. In some embodiments, the VRM data VD71 includes resistances, inductances and capacitances (RLC) of the VRM of the IVR. In some embodiments, the operation OP722 is performed by a physical-aware RLC model.

At the operation OP723, RLC data RD71 of the semiconductor device 100 is extracted from the modeling data MD1-MD3 and MD71. In some embodiments, the RLC data VD71 includes resistances, inductances and capacitances (RLC) of the dies (such as the dies DM11-DM13 and DC11-DC13) and the package (such as the molding of the dies DM11-DM13 and DC11-DC13). In some embodiments, the operation OP723 is performed by a physical-aware die and package RLC model.

In some embodiments, when the IVR is used in the semiconductor device 100, the modeling data MD2 includes specification of the IVR, such as at least one of input voltage, output voltage, maximum overshoot or undershoot, maximum delta current and maximum bandwidth. Then, preset element parameters (such as the resistances and the inductances of the IVR and resistances and capacitances of the feedback circuit) of the specification of the IVR are calculated for operation OP73.

At the operation OP73, the IVR data ID71 is compared with the preset element parameters, to determine whether the LC physics of the IVR data ID71 fulfill the specification of the IVR. When the IVR data ID71 meets the preset element parameters, the operation OP74 is performed after the operation OP73.

When the IVR data ID71 does not meet the preset element parameters, the operation OP76 is performed after the operation OP73, to generate a report indicating that the IVR data ID71 does not meet the preset element parameters. Then, the modeling data MD1 and MD2 are adjusted, and the operations OP71-OP73 are performed again for the adjusted modeling data MD1 and MD2.

For example, when an inductance of the IVR data ID71 is larger than an inductance of the preset element parameters, the operation OP74 is performed after the operation OP73. When the inductance of the IVR data ID71 is smaller than the inductance of the preset element parameters, the operation OP76 is performed after the operation OP73, and the modeling data MD1 and MD2 are adjusted to increase the inductance of the IVR data ID71.

At the operation OP74, matrix data MD71 is generated according to the IVR data ID71, the VRM data VD71 and the RLC data RD71. In some embodiments, the matrix data MD71 includes an admittance matrix and a susceptance matrix associated with dynamic IR of the entire semiconductor device 100. In some embodiments, the matrix data MD71 includes dynamic IR values of each of the grids GR1. In some embodiments, the matrix data MD71 is generated by performing MNA.

At the operation OP75, dynamic IR analysis and power analysis are performed to the matrix data MD71. In some embodiments, the operation OP75 is performed by a performance KPI engine. As illustratively shown in FIG. 7, the operation OP75 includes operations OP751-OP752.

At the operation OP751, dynamic IR analysis is performed to the matrix data MD71 to generate dynamic IR data DD71. In some embodiments, the dynamic IR data DD71 includes first voltage droops and system impedance of the semiconductor device 100. The first voltage droops are critical voltage droops when the semiconductor device 100 is turned on or a load current of the semiconductor device 100 is changed.

At the operation OP752, power analysis is performed to the matrix data MD71 to generate power data PD71. In some embodiments, the power data PD71 includes DC-DC power conversion breakdown data and system power efficiency. The DC-DC power conversion breakdown data includes loss of the voltage regulator, such as switching loss and conduction loss.

At the operation OP76, parameters PM71 are generated according to the dynamic IR data DD71 and the power data PD71. In some embodiments, the parameters PM71 include a report of IVR specification against physical LC from 3D stack topology, transient simulation data, alternating current (AC) simulation data and stage by stage DC-DC power conversion loss and efficiency report.

In some embodiments, after the operation OP76, the parameters PM71 are compared with the preset parameters corresponding to the design criteria. When the parameters PM71 meet the design criteria, the semiconductor device 100 is manufactured based on the modeling data MD1-MD3 and MD71. When the parameters PM71 does not meet the design criteria, the modeling data MD1, MD2 and MD71 are adjusted, and then the operations OP71-OP76 are performed again to the adjusted modeling data MD1, MD2 and MD71 and the fixed modeling data MD3.

For example, referring to FIG. 7 and FIG. 2A, after the operation OP76, the operation OP25 is performed to the parameters PM71. The parameters PM71 are embodiments of the parameters PM21. When the parameters PM71 meet the design criteria, the operation OP26 is performed. When the parameters PM71 does not meet the design criteria, the operation OP22 is performed again to update the specification data SD21 including the modeling data MD1, MD2 and MD71.

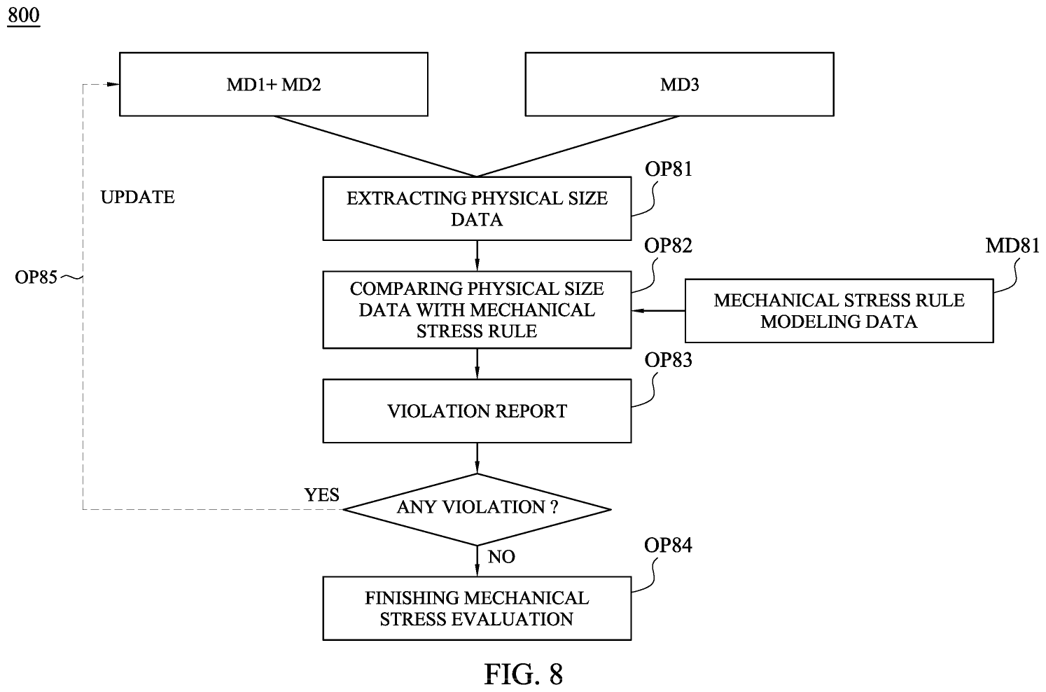

FIG. 8 is a flowchart diagram of a method 800 corresponding to the operation EN24 shown in FIG. 2A, in accordance with some embodiments of the present disclosure. As illustratively shown in FIG. 8, the method 800 includes operations OP81-OP86. In some embodiments, the method 800 is performed by a processor and a memory.

At the operation OP81, physical size data of the semiconductor device 100 is extracted from the modeling data MD1-MD3. In some embodiments, the physical size data includes the lengths of the dies DM11-DM13 and DC11-DC13 along X direction, Y direction and Z direction, pitches between the dies DM11-DM13 and DC11-DC13, density (such as metal density) of the semiconductor device 100, and other physical parameters of the semiconductor device 100. Referring to FIG. 3 and FIG. 2A, the physical size data includes the parameters PM24 in some embodiments.

At the operation OP82, the physical size data is compared with high-level mechanical stress rules modeling data MD81, to check whether the physical size data meets the design criteria associated with the mechanical stress rules. In some embodiments, the operation OP82 is performed by a mechanical stress checker corresponding to the mechanical stress analysis engine shown in FIG. 2B.

At the operation OP83, a violation report is generated according to the comparison result of the operation OP82. When the physical size data meets the design criteria, the violation report indicates that there is no violation regarding the mechanical stress rules modeling data MD81. When the physical size data does not meet the design criteria, the violation report indicates that at least one violation exists regarding the mechanical stress rules modeling data MD81.

When no violation in the violation report, the operation OP84 is performed after the operation OP83. When at least one violation exists in the violation report, the operation OP85 is performed after the operation OP83.

At the operation OP84, the evaluation of mechanical stress rules for the specification data SD21 is finished. In some embodiments, at the operation OP84, mechanical stress estimation is performed over 3DIC report. In some embodiments, after the operation OP84, implementations of the specification data SD21, such as the operation OP26 shown in FIG. 2A, is performed. In some embodiments, after the operation OP84, other evaluations are performed to the specification data SD21.

At the operation OP85, the modeling data MD1, MD2 is updated according to the violation report. For example, when the violation report indicates that a geometry configuration of the specification data SD21 does not meet the design criteria, parameters in the modeling data MD1, MD2 associated with the geometry configuration are adjusted. It is noted that the modeling data MD3 is fixed and not updated at the operation OP85. After the operation OP85, the operation OP81 is performed again to the updated modeling data MD1, MD2 and the fixed modeling data MD3.

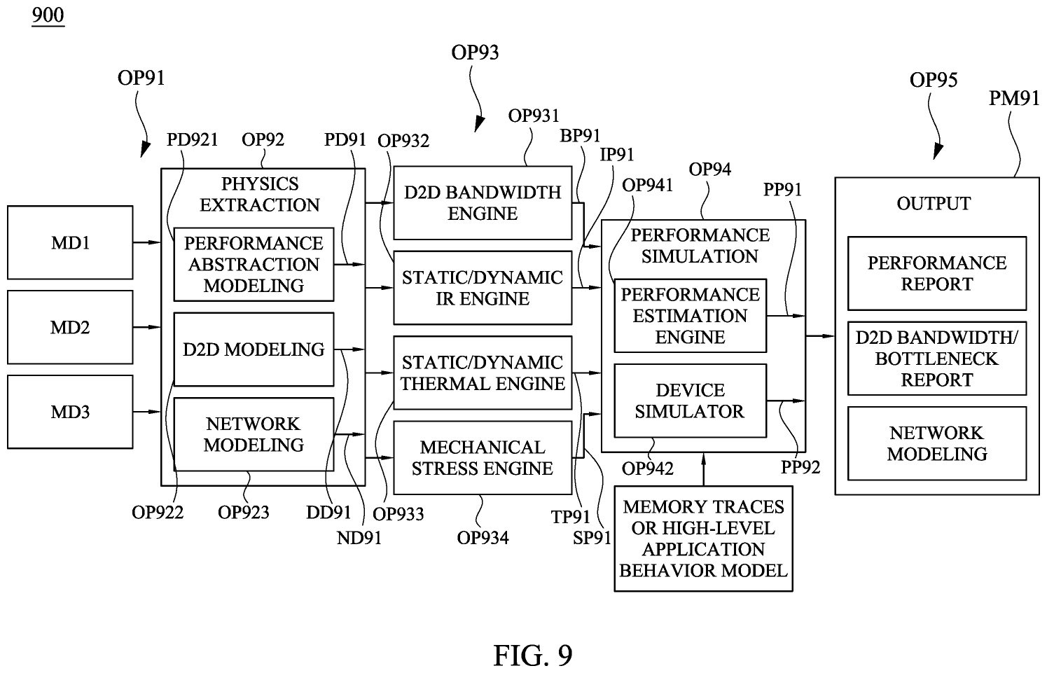

FIG. 9 is a flowchart diagram of a method 900 corresponding to the operation EN26 shown in FIG. 2B, in accordance with some embodiments of the present disclosure. As illustratively shown in FIG. 9, the method 900 includes operations OP91-OP95. In some embodiments, the method 900 is performed by a processor and a memory.

At the operation OP91, the modeling data MD1-MD3 are inputted into the processor for a performance evaluation. In some embodiments, for the performance evaluation, the modeling data MD2 includes at least a part of data associated with power of different xPU and high level xPU key KPI abstraction (such as industrial PC (IPC) and giga floating-point operations per second (GFLOPS)). The xPU is referred to as central processing unit (CPU), graphics processing unit (GPU), data processing unit (DPU) or other processing units.

At the operation OP92, physical parameters associated with the performance evaluation are extracted from the modeling data MD1-MD3. As illustratively shown in FIG. 9, the operation OP92 includes operations OP921-OP923.

At the operation OP921, performance data PD91 is generated according to the modeling data MD1-MD3. In some embodiments, the operation OP921 is performed by xPU performance modeling.

At the operation OP922, D2D data DD91 is generated according to the modeling data MD1-MD3. In some embodiments, the operation OP922 is performed by D2D modeling.

At the operation OP923, network data ND91 is generated according to the modeling data MD1-MD3. In some embodiments, the operation OP923 is performed by xPU network modeling.

At the operation OP93, various parameters associated with the performance evaluation are generated according to the performance data PD91, the D2D data DD91 and the network data ND91. As illustratively shown in FIG. 9, the operation OP93 includes operations OP931-OP933.

At the operation OP931, the D2D bandwidth engine generates bandwidth parameters BP91 of the semiconductor device 100 according to the performance data PD91, the D2D data DD91 and the network data ND91. Referring to FIG. 2A, FIG. 4 and FIG. 9, in some embodiments, the D2D bandwidth engine also performs the operation EN22 and the method 400.

At the operation OP932, the static/dynamic IR engine generates IR parameters IP91 of the semiconductor device 100 according to the performance data PD91, the D2D data DD91 and the network data ND91. Referring to FIG. 2A, FIG. 5, FIG. 7 and FIG. 9, in some embodiments, the static/dynamic IR engine also performs the operation EN21 and the methods 500, 700.

At the operation OP933, the static/dynamic thermal engine generates thermal parameters TP91 of the semiconductor device 100 according to the performance data PD91, the D2D data DD91 and the network data ND91. Referring to FIG. 2A, FIG. 6 and FIG. 9, in some embodiments, the static/dynamic thermal engine also performs the operation EN23 and the methods 600.

At the operation OP934, the mechanical stress engine generates mechanical stress parameters SP91 of the semiconductor device 100 according to the performance data PD91, the D2D data DD91 and the network data ND91. Referring to FIG. 2A, FIG. 8 and FIG. 9, in some embodiments, the mechanical stress engine also performs the operation EN24 and the methods 800.

At the operation OP94, xPU performance simulation is performed to the bandwidth parameters BP91, the IR parameters IP91, the thermal parameters TP91 and the mechanical stress parameters SP91. As illustratively shown in FIG. 9, the operation OP94 includes operations OP941-OP942. In some embodiments, memory traces or high-level application behavior models are used for the operation OP94.

At the operation OP941, performance estimation is performed to the bandwidth parameters BP91, the IR parameters IP91, the thermal parameters TP91 and the mechanical stress parameters SP91, to generate performance parameters PP91. In some embodiments, the operation OP941 is performed by a performance estimation engine with IR, thermal, stress impact effects.

At the operation OP942, performance parameters PP92 are generated according to the bandwidth parameters BP91, the IR parameters IP91, the thermal parameters TP91 and the mechanical stress parameters SP91. In some embodiments, the operation OP942 is performed by third party cycle-accurate or coarse-grained simulators, in which the simulators correspond to at least one of xPU, network operation center (NOC) and memory.

At the operation OP95, parameters PM91 are generated according to the performance parameters PP91 and PP92. In some embodiments, the parameters PM91 include system level xPU performance reports, D2D bandwidth and bottleneck reports and system level power reports.

In some embodiments, after the operation OP95, the parameters PM91 are compared with the preset parameters corresponding to the design criteria. When the parameters PM91 meet the design criteria, the semiconductor device 100 is manufactured based on the modeling data MD1-MD3. When the parameters PM91 does not meet the design criteria, the modeling data MD1 and MD2 are adjusted, and then the operations OP91-OP95 are performed again to the adjusted modeling data MD1 and MD72 and the fixed modeling data MD3.

For example, referring to FIG. 9, FIG. 2A and FIG. 2B, after the operation OP95, the operation OP25 is performed to the parameters PM91. The parameters PM91 are embodiments of the parameters PM26. When the parameters PM91 meet the design criteria, the operation OP26 is performed. When the parameters PM91 does not meet the design criteria, the operation OP22 is performed again to update the specification data SD21 including the modeling data MD1 and MD2.

Also disclosed is a method. The method includes generating first specification data of a semiconductor device; performing, to the first specification data, a first evaluation operation corresponding to a first physical feature to the first specification data, to generate first parameters; performing, to the first specification data, a second evaluation operation corresponding to a second physical feature different from the first physical feature, to generate second parameters; comparing the first parameters and the second parameters with preset parameters; and when the first parameters and the second parameters meet the preset parameters, manufacturing the semiconductor device according to the first specification data.

Also disclosed is a method. The method includes performing, to first specification data of a semiconductor device, a first evaluation operation of a first physical feature and a second evaluation operation of a second physical feature simultaneously, to generate first parameters and second parameters; comparing the first parameters and the second parameters with preset parameters; when the first parameters and the second parameters meet the preset parameters, manufacturing the semiconductor device according to the first specification data; and when the first parameters and the second parameters do not meet the preset parameters, adjusting the first specification data. The first physical feature is different from the second physical feature, and the first parameters and the second parameters correspond to the first physical feature and the second physical feature, respectively.

Also disclosed is a method. The method includes dividing a semiconductor device into a plurality of grids; generating first physical data of each of the plurality of grids based on first specification data of the semiconductor device; generating second physical data of each of the plurality of grids based on the first specification data; performing a first evaluation operation of a first physical feature to the first physical data, to generate first parameters; performing a second evaluation operation of a second physical feature to the second physical data, to generate second parameters; comparing the first parameters and the second parameters with preset parameters; and when the first parameters and the second parameters do not meet the preset parameters, adjusting the first specification data. The first physical feature is different from the second physical feature.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
generating first specification data of a semiconductor device;
performing, to the first specification data, a first evaluation operation corresponding to a first physical feature to the first specification data, to generate first parameters;
performing, to the first specification data, a second evaluation operation corresponding to a second physical feature different from the first physical feature, to generate second parameters;
comparing the first parameters and the second parameters with preset parameters; and
when the first parameters and the second parameters meet the preset parameters, manufacturing the semiconductor device according to the first specification data.

2. The method of claim 1, further comprising:
when the first parameters and the second parameters do not meet the preset parameters, adjusting the first specification data to generate second specification data; and
after the first specification data is adjusted, generating the first parameters and the second parameters based on the second specification data.

3. The method of claim 1, further comprising:
selecting the first evaluation operation and second first evaluation operation from a plurality of evaluation operations according to the first specification data.

4. The method of claim 3, further comprising:
when the first specification data includes data corresponding to a third physical feature, selecting a third evaluation operation corresponding to the third physical feature from the plurality of evaluation operations;
when the third evaluation operation is selected, performing the third evaluation operation to the first specification data, to generate third parameters;
comparing the first parameters, the second parameters and the third parameters with the preset parameters; and
when the first parameters, the second parameters and the third parameters meet the preset parameters, manufacturing the semiconductor device according to the first specification data.

5. The method of claim 4, wherein when the first specification data does not include the data associated with the third physical feature, the third evaluation operation is not performed.

6. The method of claim 1, further comprising:
extracting physical data from the first specification data;
dividing the semiconductor device into a plurality of grids;
generating grid data according to the physical data; and
generating the first parameters according to the grid data,
wherein the grid data includes physical values of each of the plurality of grids.

7. The method of claim 1, further comprising:
extracting first physical data and second physical data from the first specification data;
comparing the first physical data with preset element parameters;
when the first physical data do not meet the preset element parameters, adjusting the first specification data; and
when the first physical data meets the preset element parameters, generating the first parameters according to the first physical data and the second physical data,
wherein the first physical data is different from the second physical data.

8. The method of claim 7, further comprising:
dividing the semiconductor device into a plurality of grids;
when the first physical data meets the preset element parameters, generating matrix data; and
generating the first parameters according to the matrix data,
wherein the matrix data includes physical values of plurality of grids, and
the matrix data is not generated when the first physical data do not meet the preset element parameters.

9. A method, comprising:
performing, to first specification data of a semiconductor device, a first evaluation operation of a first physical feature and a second evaluation operation of a second physical feature simultaneously, to generate first parameters and second parameters;
comparing the first parameters and the second parameters with preset parameters;
when the first parameters and the second parameters meet the preset parameters, manufacturing the semiconductor device according to the first specification data; and
when the first parameters and the second parameters do not meet the preset parameters, adjusting the first specification data,
wherein the first physical feature is different from the second physical feature, and
the first parameters and the second parameters correspond to the first physical feature and the second physical feature, respectively.

10. The method of claim 9, further comprising:
when the first parameters and the second parameters do not meet the preset parameters, performing, to second specification data of the semiconductor device, the first evaluation operation and the second evaluation operation simultaneously; and
when the second specification data meet the preset parameters, manufacturing the semiconductor device according to the second specification data,
wherein the second specification data is different from the first specification data.

11. The method of claim 9, further comprising:
when the first specification data includes data associated with the first evaluation operation, the second evaluation operation and a third evaluation operation of a third physical feature, performing, to the first specification data, the first evaluation operation, the second evaluation operation and the third evaluation operation simultaneously, to generate the first parameters, the second parameters and third parameters;
comparing the first parameters, the second parameters and the third parameters with the preset parameters; and
when the first parameters, the second parameters and the third parameters meet the preset parameters, manufacturing the semiconductor device according to the first specification data.

12. The method of claim 9, wherein performing the first evaluation operation comprises:
calculating a plurality of electrical conductivities of each of a plurality of grids of the semiconductor device based on the first specification data; and
generating the first parameters based on the plurality of electrical conductivities.

13. The method of claim 12, wherein calculating the plurality of electrical conductivities comprises:
calculating six electrical conductivities of six surfaces of one grid of the plurality of grids.

14. The method of claim 12, wherein performing the second evaluation operation comprises:
extracting a plurality of thermal conductivities of each of the plurality of grids of the semiconductor device from the first specification data; and
generating the second parameters based on the plurality of thermal conductivities.

15. The method of claim 12, wherein performing the second evaluation operation comprises:
extracting physical data from the first specification data;
comparing the physical data with preset element parameters;
when the physical data do not meet the preset element parameters, adjusting the first specification data; and
when the physical data meets the preset element parameters, generating the first parameters according to the physical data.

16. The method of claim 15, further comprising:
dividing the semiconductor device into a plurality of grids;
when the physical data meets the preset element parameters, generating matrix data; and
generating the first parameters according to the matrix data,
wherein the matrix data includes physical values of the plurality of grids, and
the matrix data is not generated when the physical data do not meet the preset element parameters.

17. A method, comprising:
dividing a semiconductor device into a plurality of grids;
generating first physical data of each of the plurality of grids based on first specification data of the semiconductor device;
generating second physical data of each of the plurality of grids based on the first specification data;
performing a first evaluation operation of a first physical feature to the first physical data, to generate first parameters;
performing a second evaluation operation of a second physical feature to the second physical data, to generate second parameters;
comparing the first parameters and the second parameters with preset parameters; and
when the first parameters and the second parameters do not meet the preset parameters, adjusting the first specification data,
wherein the first physical feature is different from the second physical feature.

18. The method of claim 17, wherein the first evaluation operation and the second evaluation operation are performed simultaneously.

19. The method of claim 17, further comprising:
extracting physical data from the first specification data;
when the physical data meets preset element parameters, generating matrix data according to the physical data;
generating third parameters based on the matrix data;
comparing the third parameters with the preset parameters;
when the third parameters do not meet the preset parameters, adjusting the first specification data; and
when the third parameters meet the preset parameters, manufacturing the semiconductor device according to the first specification data.

20. The method of claim 19, further comprising:
when the physical data do not meet the preset element parameters, adjusting the first specification data without generating the matrix data.
